(19) United States
(12) Patent Application Publication
(10) Pub. No.: US 2026/0350411 A1
(43) Pub. Date: Nov. 5, 2026

(54) METHOD AND APPARATUS FOR MONITORING OF ARTIFICIAL INTELLIGENCE/MACHINE LEARNING MODELS

(71) Applicant: MEDIATEK INC., Hsinchu City (TW)

(72) Inventors: Pedram Kheirkhah Sangdeh, San Jose, CA (US); Yu-Ching HUANG, Hsinchu City (TW); Gyu Bum KYUNG, San Jose, CA (US)

(73) Assignee: MEDIATEK INC., Hsinchu City (TW)

(21) Appl. No.: 19/472,812

(22) PCT Filed: Feb. 16, 2024
(86) PCT No.: PCT/US2024/016111

§ 371 Date: Oct. 6, 2025

(51) Int. Cl. G06N 3/096

(52) U.S. Cl. CPC G06N 3/096

(57) ABSTRACT

Techniques pertaining to quantization for artificial intelligence and machine learning (AI/ML) models in wireless communications are described. An apparatus performs quantization with respect to an AI/ML model. The apparatus then performs a wireless communication by utilizing the AI/ML model

### TECHNICAL FIELD

The present disclosure is generally related to wireless communications and, more particularly, to monitoring of artificial intelligence and machine learning (AI/ML) models in wireless communications.

### BACKGROUND

Unless otherwise indicated herein, approaches described in this section are not prior art to the claims listed below and are not admitted as prior art by inclusion in this section.

In a communication system, such as wireless communications in accordance with the 3^{rd} Generation Partnership Project (3GPP) standards, many functions on the user equipment (UE) side tend to have a corresponding twin on the network side, and vice versa. In the context of AI/ML, this may be referred to as a two-sided autoencoder-based AI/ML model, also known as autoencoders. Using channel state information (CSI) compression as an example application scenario, the UE side of a two-sided AI/ML model (equipped with an encoder and a CSI construction module) translates CSI into a compressed representation. Correspondingly, the network side of the two-sided AI/ML model (equipped with a decoder and a CSI reconstruction module) reconstructs CSI from its compressed representation. In general, the encoder and decoder in the two-sided AI/ML model can be specifically trained for a certain cell, area, configuration and/or scenario.

With respect to monitoring of AI/ML models, there are different approaches of monitoring which may be undertaken on the UE side and/or the network side. However, there are certain challenges regarding monitoring. For instance, in terms of model optimization, a proxy decoder used by a network node (e.g., gNB) may be designed regardless of the UE's constraints. Consequently, the UE may require re-compiling, quantizing, and pruning of the proxy decoder to fit its budget. Moreover, in terms of intra-vendor scalability, a UE vendor may need proxies with different complexities and/or accuracies, and each proxy would be designed and provided by a respective network node vendor. Furthermore, in terms of inter-vendor scalability, for a single scenario/configuration, the UE may need to receive many proxy decoders from different network node vendors. Yet, none of the proxy decoders is likely optimized for the UE's use. Besides, there may be storage problem as well as complicated uploading issues in the future for proxy models. Therefore, there is need for a solution of techniques for monitoring of AI/ML models in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure pertain to monitoring of AI/ML models in wireless communications. It is believed that implementations of the various proposed schemes may address or otherwise alleviate the aforementioned issue(s). The various schemes proposed herein may be utilized in a variety of applications and scenarios such as, for example and without limitation, CSI compression, denoising (or noise reduction), quantization, coding, error correction codes, modulation, peak-to-average power ratio (PAPR) reduction, and image compression.

In one aspect, a method may involve preparing a two-sided AI/ML model using information from a network. The method may also involve monitoring the two-sided AI/ML model in a wireless communication with the network.

In another aspect, an apparatus may include a transceiver configured to communicate wirelessly and a processor coupled to the transceiver. The processor may prepare a two-sided AI/ML model using information from a network. The processor may also monitor the two-sided AI/ML model in a wireless communication with the network.

It is noteworthy that, although description provided herein may be in the context of certain radio access technologies, networks, and network topologies for wireless communication, such as 5^{th} Generation (5G)/New Radio (NR) mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example scenario in accordance with an implementation of the present disclosure.

FIG. 5 is a diagram of an example scenario in accordance with an implementation of the present disclosure.

FIG. 6 is a diagram of an example scenario in accordance with an implementation of the present disclosure.

FIG. 7 is a diagram of an example scenario in accordance with an implementation of the present disclosure.

FIG. 8 is a diagram of an example scenario in accordance with an implementation of the present disclosure.

FIG. 9 is a diagram of an example scenario in accordance with an implementation of the present disclosure.

FIG. 10 is a block diagram of an example communication system in accordance with an implementation of the present disclosure.

FIG. 11 is a flowchart of an example process in accordance with an implementation of the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to monitoring of AI/ML models in wireless communications. According to the present disclosure, a number of possible solutions may be implemented separately or jointly. That is, although these possible solutions may be described below separately, two or more of these possible solutions may be implemented in one combination or another.

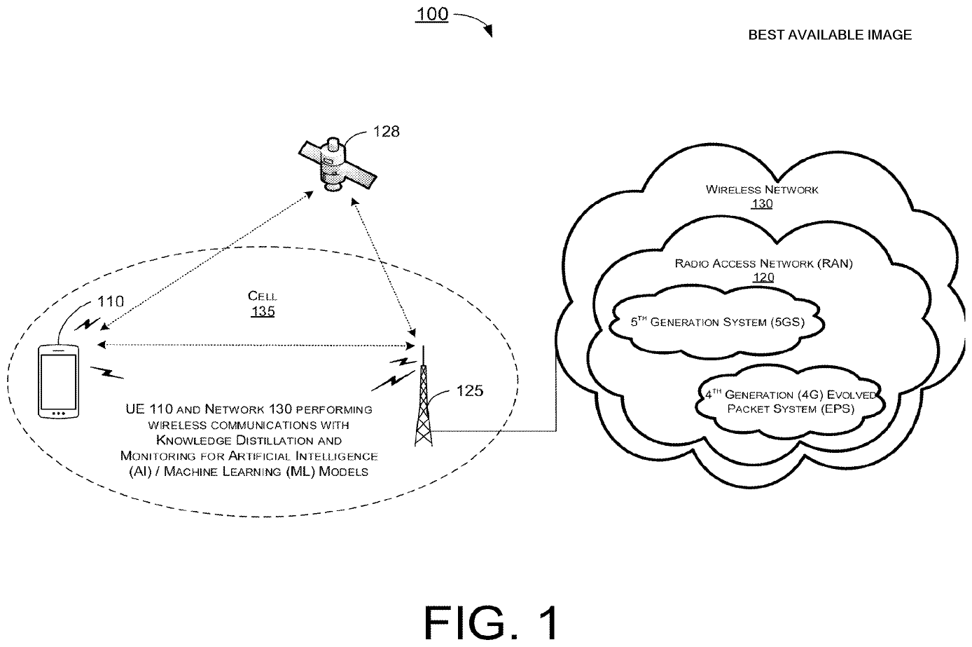

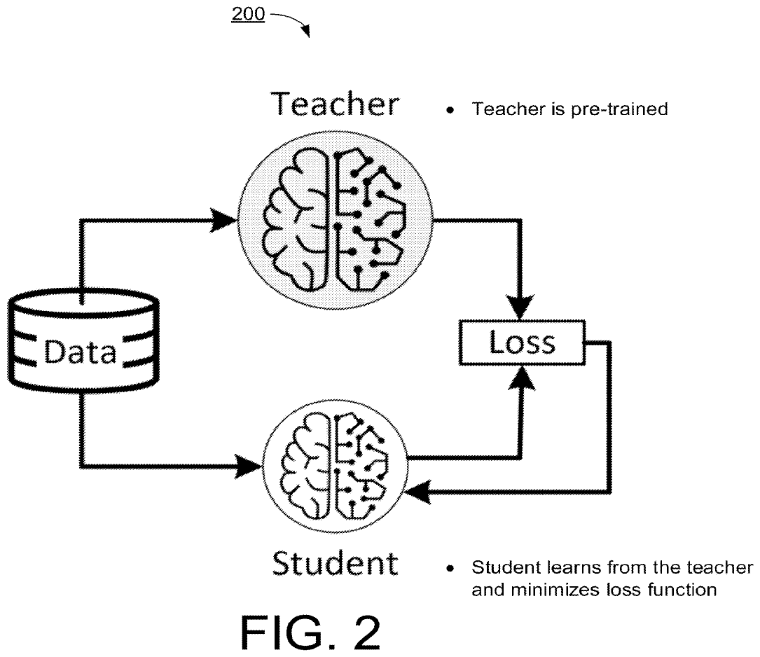

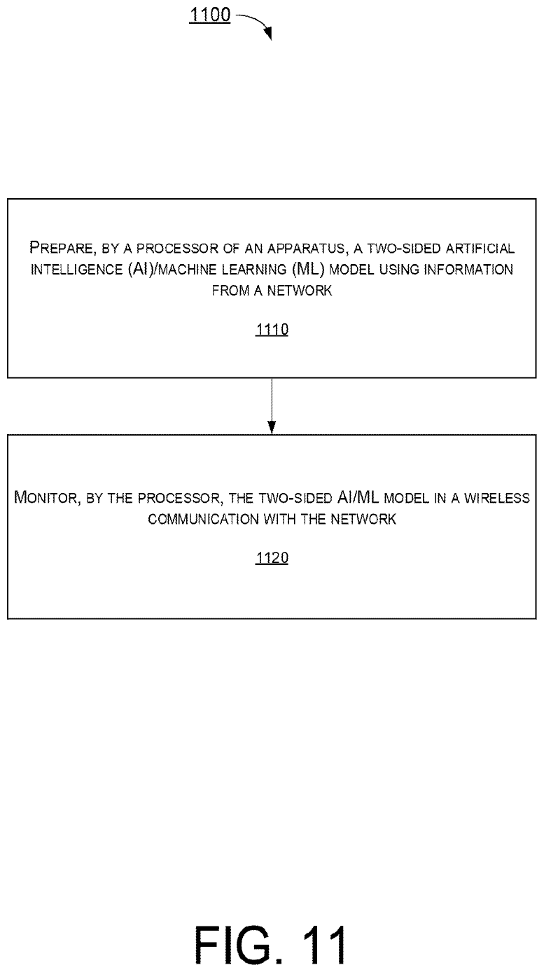

FIG. 1 illustrates an example network environment 100 in which various solutions and schemes in accordance with the present disclosure may be implemented. FIG. 2 ~FIG. 11 illustrate examples of implementation of various proposed schemes in network environment 100 in accordance with the present disclosure. The following description of various proposed schemes is provided with reference to FIG. 1 ~FIG. 11.

Referring to FIG. 1, network environment 100 may involve a UE 110 in wireless communication with a radio access network (RAN) 120 (e.g., a 5G NR mobile network or another type of network such as a non-terrestrial network (NTN)). UE 110 may be in wireless communication with RAN 120 via a terrestrial network node 125 (e.g., base station, eNB, gNB or transmit-and-receive point (TRP)) or a non-terrestrial network node 128 (e.g., satellite) and UE 110 may be within a coverage range of a cell 135 associated with terrestrial network node 125 and/or non-terrestrial network node 128. RAN 120 may be a part of a network 130. In network environment 100, UE 110 and network 130 (via terrestrial network node 125 and/or non-terrestrial network node 128) may implement various schemes pertaining to monitoring of AI/ML models in wireless communications, as described below. In the present disclosure, the two-sided AI/ML model may be under training for the application of CSI compression, noise reduction, quantization, coding, error correction codes, modulation, PAPR reduction, and/or image compression. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

One approach of AI/ML monitoring may involve UE-side monitoring with intermediate key performance indicator (KPI). Under this approach, a network node (e.g., gNB) sends a replica of its decoder to the UE. The UE then persistently monitors reconstruction accuracy using its encoder and the decoder provided by the network node. The UE also reports reconstruction accuracy to the network node for monitoring action(s). However, there are some disadvantages associated with this approach. For instance, the UE's computation and time budget may not afford the decoder provided by the network node. Additionally, the proprietary nature, or proprietariness, of the network node's decoder cannot be maintained. Moreover, a proprietary model format used cannot be used in this approach.

Another approach of AI/ML monitoring may involve network-side monitoring with intermediate KPI. Under this approach, the UE optionally sends its encoder to a network node (e.g., gNB) of the network. The UE periodically sends raw measurement(s) to the network node. The network node measures intermediate KPI(s) after passing input into an encoder and a decoder. The network node can also initiate a monitoring action (e.g., activation, deactivation, fallback, and so forth). However, there are some disadvantages associated with this approach. For instance, the UE's encoder is not optimized for the network's usage. Additionally, the UE may need to disclosure its encoder to the network. Also, proprietary model format cannot be used. Moreover, there may be a large airtime overhead in sending the raw measurements.

Still another approach of AI/ML monitoring involves proxy-decoder-based (PDB model monitoring. That is, a proxy decoder is trained on the network side (e.g., at a gNB of the network) under this approach. For instance, the gNB can train a simplified decoder (e.g., proxy decoder) to mimic an actual decoder used by the gNB. The proxy decoder is designed such that its resultant KPI is consistently drifted from that of the actual decoder. With respect to PDB monitoring at the UE, the network provides a proxy decoder, and possibly information about the expected drift, to the UE. The UE then consistently monitors the drifted KPI to detect any monitoring event. In the context of CSI compression, the UE uses its encoder to compress CSI and also uses the proxy decoder to recover the CSI. Based on the KPI calculated with the output of the proxy decoder, the UE reports a drifted KPI or any relevant indicator if a monitoring event is detected.

Nevertheless, there are challenges associated with above-described approaches. In terms of model optimization, the network is likely to design its proxy decoder without considering constraints on the UE side, and the UE may need to re-compile, quantize and prune the proxy decoder in order to fit its budget. In terms of intra-vendor scalability, a UE vendor would need proxies with different complexities and/or accuracies, with each proxy designed and provided by a respective network node (e.g., gNB) vendor. In terms of inter-vendor scalability, for a single scenario/configuration, the UE may need to receive many proxy decoders from different network node vendors. However, none of the proxy decoders is likely optimized for use by the UE, not to mention there would be storage problem to store many different proxy decoders as well as complications in future updates for proxy models.

FIG. 2 illustrates an example scenario 200 under a proposed scheme in accordance with the present disclosure. Under the proposed scheme, knowledge distillation may be performed to transfer the knowledge from a large model (herein interchangeably referred to as the “teacher”) to a single, smaller model (herein interchangeably referred to as the “student”), as shown in FIG. 2. The transferred knowledge may be of one or more types, including: response-based knowledge, relation-based knowledge, and feature-based knowledge. The response-based knowledge may focus on matching outputs of a student and a teacher. The teacher may be pre-trained and implemented as a decoder of a network node (e.g., gNB). The student may be learning from the teacher and may be implemented as a proxy decoder of a UE.

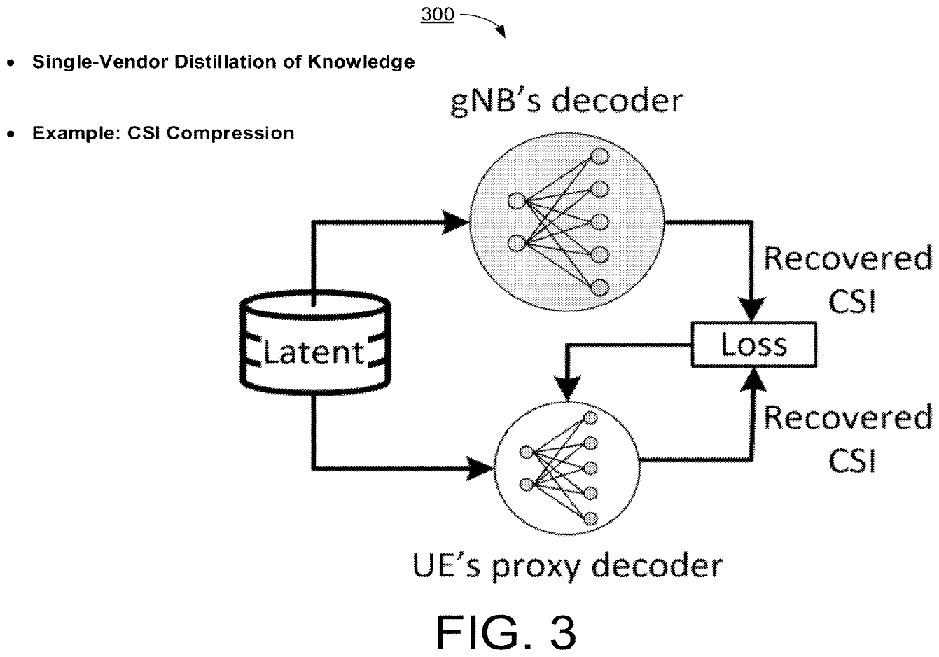

FIG. 3 illustrates an example scenario 300 under a proposed scheme in accordance with the present disclosure. Under the proposed scheme, a single-vendor distillation may involve designing and training a decoder proxy by a UE (e.g., UE 110). The UE may design its own proxy decoder based on its constraints and needs. The UE and a network node (e.g., gNB) of a network may share a dataset including latent vectors and corresponding target samples. By minimizing the loss function, the knowledge of the network node's decoder may be transferred to the UE, as shown in FIG. 3 (with CSI compression being the example application scenario). There may be some advantages associated with this proposed scheme, including (but not limited to) UE-optimized proxy decoder being designed and used by the UE, no need for model transfer, and no need for CSI report (in the context of CSI compression) in monitoring.

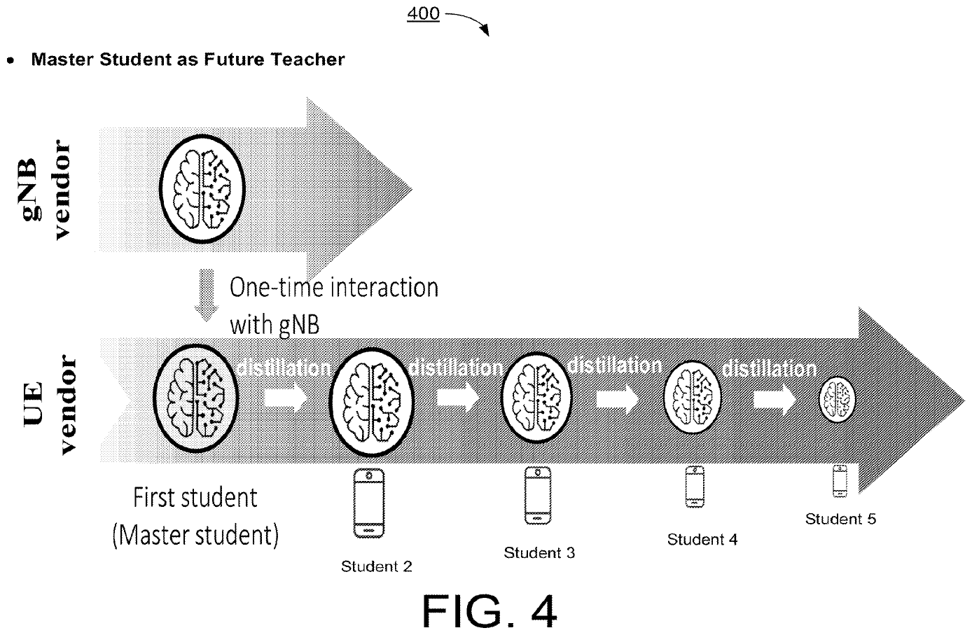

FIG. 4 illustrates an example scenario 400 under a proposed scheme in accordance with the present disclosure. Under the proposed scheme, a current student may function as a future teacher. For instance, a first student (herein interchangeably referred to as a “master student”) may teach new students what it learned from its teacher during a one-time interaction with the teacher, as shown in FIG. 4. Thus, in case that a UE vendor obtains a proxy decoder, it may generate many proxy decoders based on the needs of its various devices. Advantageously, this proposed scheme may address the intra-vendor scalability issue.

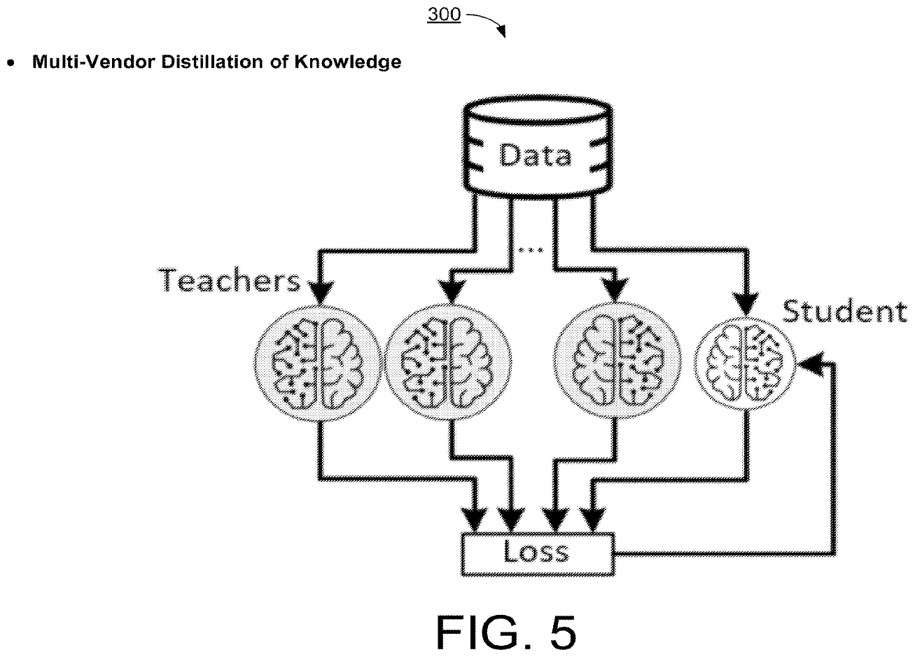

FIG. 5 illustrates an example scenario 500 under a proposed scheme in accordance with the present disclosure. Under the proposed scheme, a multi-vendor distillation may involve multi-teacher knowledge distillation to a single student, as shown in FIG. 5. That is, a student may learn from multiple teachers, and network node (e.g., gNB) vendors may be a UE vendor's teacher. The UE may learn a single proxy decoder from all network node vendors, thereby resulting in one proxy decoder that works with multiple gNB vendors. Advantageously, the proposed scheme may address the inter-vendor scalability issue.

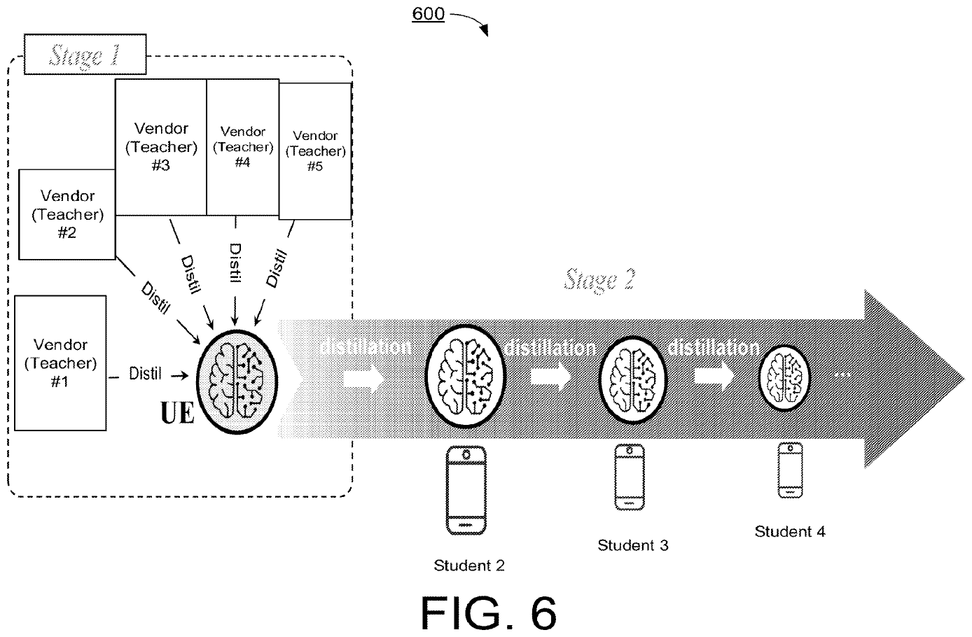

FIG. 6 illustrates an example scenario 600 under a proposed scheme in accordance with the present disclosure. Under the proposed scheme, an overall distillation process may include two-stage distillation, as shown in FIG. 6. At a first stage (stage 1), a gigantic master student may learn as much as possible from different network node vendors. At a second stage (stage 2), the master student may be kept on a UE's server and may be used for teaching simpler students.

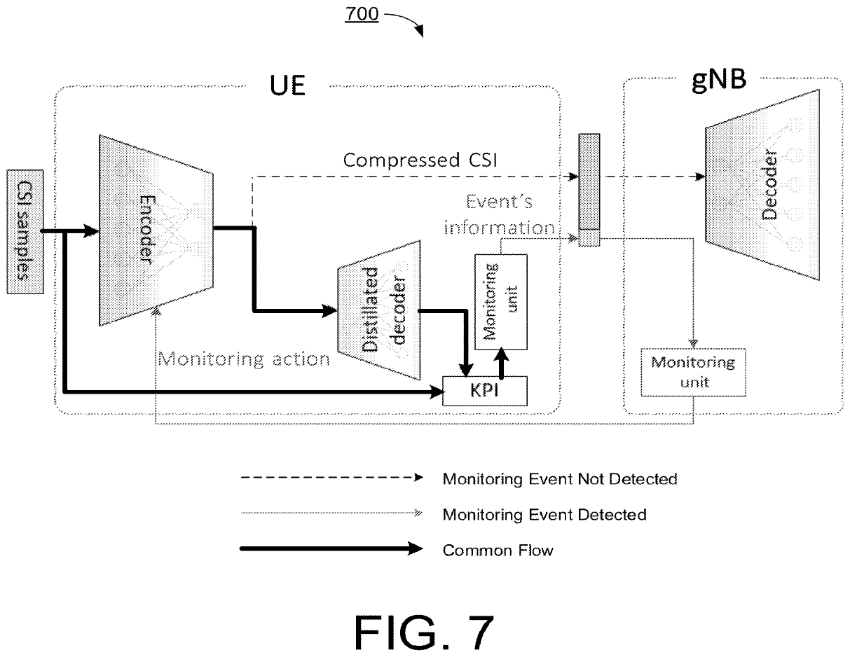

FIG. 7 illustrates an example scenario 700 under a proposed scheme in accordance with the present disclosure. Under the proposed scheme, monitoring may be performed by a distillated proxy decoder. The example shown in FIG. 7 pertains to KPI-based model monitoring in the context of CSI compression. Referring to FIG. 7, the KPI-based model monitoring may involve several steps. At a first step (step 1), a UE (e.g., UE 110) may use its encoder to encode and compress an input to generate a latent vector. At a second step (step 2), the UE may measure a drifted KPI by passing the latent vector through a distillated decoder. At a third step (step 3), in an event that the drifted KPI indicates a monitoring event, the UE may report information of the event to a network node (e.g., gNB) of a network (e.g., network 130). At a fourth step (step 4), based on the monitoring event, the network node may take subsequent monitoring actions.

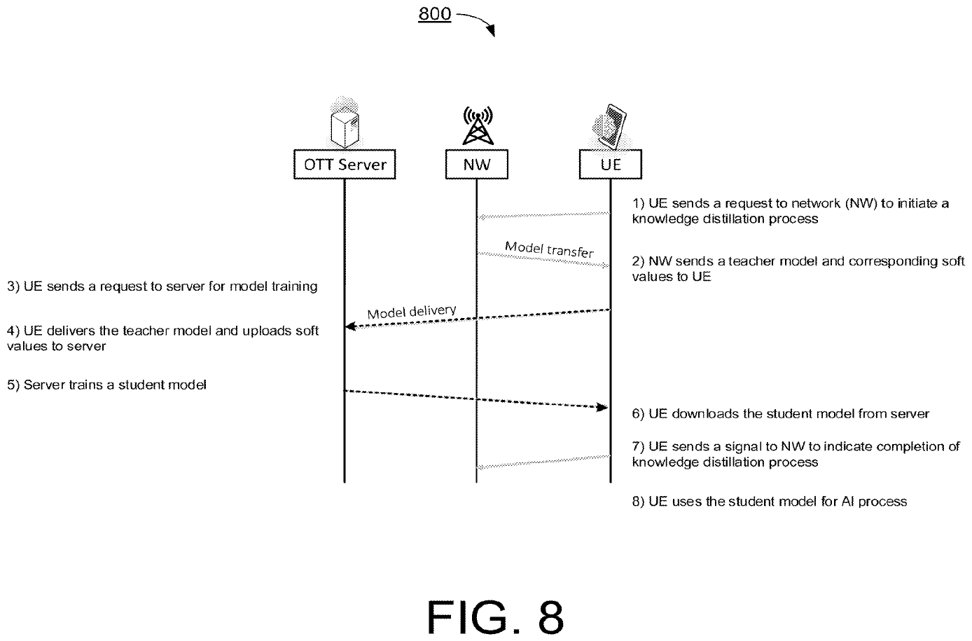

FIG. 8 illustrates an example scenario 800 under a proposed scheme in accordance with the present disclosure. Under the proposed scheme, a process of student model training may involve several steps, as shown in FIG. 8. At a first step (step 1), a UE (e.g., UE 110) may send a request to a network (e.g., network 130) to initiate a knowledge distillation process. At a second step (step 2), the network may send a teacher model and corresponding soft values to the UE. At a third step (step 3), the UE may send a request to a server (e.g., over-the-top (OTT) server as a UE-side server) for model training. At a fourth step (step 4), the UE may send the teacher model and upload the soft values to the server. At a fifth step (step 5), the server may train a student model based on the teacher model and the soft values. At a sixth step (step 6), the UE may download the student model from the server. At a seventh step (step 7), the UE may send a signal to the network to indicate that knowledge distillation is complete. At an eight step (step 8), the UE may use the student model for an AI process. It is noteworthy that, under the proposed scheme, a network-side server is not precluded from directly training the student model on it and transferring the student model to the UE. Moreover, although the server is shown in FIG. 8 as an OTT server that is separate from the UE, in some implementations the OTT server may be replaced by a processor on the UE itself.

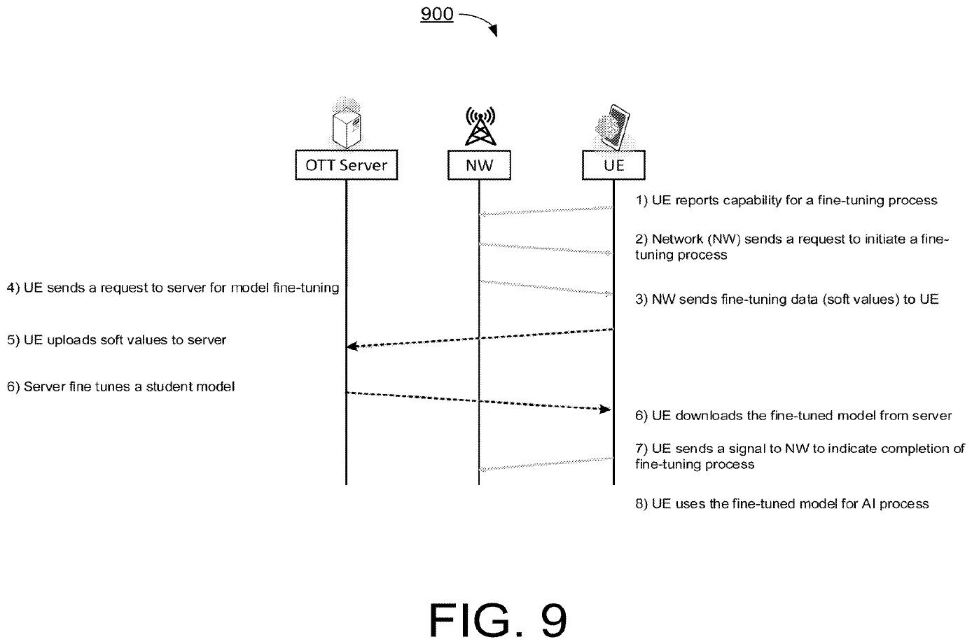

FIG. 9 illustrates an example scenario 900 under a proposed scheme in accordance with the present disclosure. Under the proposed scheme, a process of student model fine-tuning may involve several steps, as shown in FIG. 9. At a first step (step 1), a UE (e.g., UE 110) may report its capability for the fine-tuning process to a network (e.g., network 130). At a second step (step 2), the network may send a request to the UE to initiate the fine-tuning process. At a third step (step 3), the network may send fine-tuning data (soft values) to the UE. At a fourth step (step 4), the UE may send a request to a server (e.g., OTT server as a UE-side server) for model fine-tuning. At a fifth step (step 5), the UE may upload the soft values to the server. At a sixth step (step 6), the server may fine-tune a student model. At a seventh step (step 7), the UE may download the fine-tuned student model from the server. At an eighth step (step 8), the UE may send a signal to the network to indicate that the fine-tuning process is complete. At a ninth step (step 9), the UE may use the fine-tuned student model for an Al process. It is noteworthy that, under the proposed scheme, a network-side server is not precluded from directly training the student model on it and transferring the student model to the UE. Moreover, although the server is shown in FIG. 9 as an OTT server that is separate from the UE, in some implementations the OTT server may be replaced by a processor on the UE itself.

In view of the above, one of ordinary skill in the art may appreciate the plethora of advantages/benefits provided by the various schemes proposed herein. For instance, implementations of one or more of the proposed schemes may maintain the proprietary nature, or proprietariness, of the decoders designed by network node vendors. Additionally, implementations of one or more of the proposed schemes may rectify the need for periodic and aperiodic raw sample feedbacks for monitoring. Also, implementations of one or more of the proposed schemes may enable monitoring with decoders particularly optimized to be used at UE devices. Moreover, implementations of one or more of the proposed schemes may enable UE vendors to train decoders with various complexities and accuracies based on the needs of different devices. Furthermore, implementations of one or more of the proposed schemes may enable UE-side monitoring with a single proxy decoder for multiple network node vendors. In addition, implementations of one or more of the proposed schemes may entail potentially more accurate monitoring solutions compared to input-based monitoring.

### Illustrative Implementations

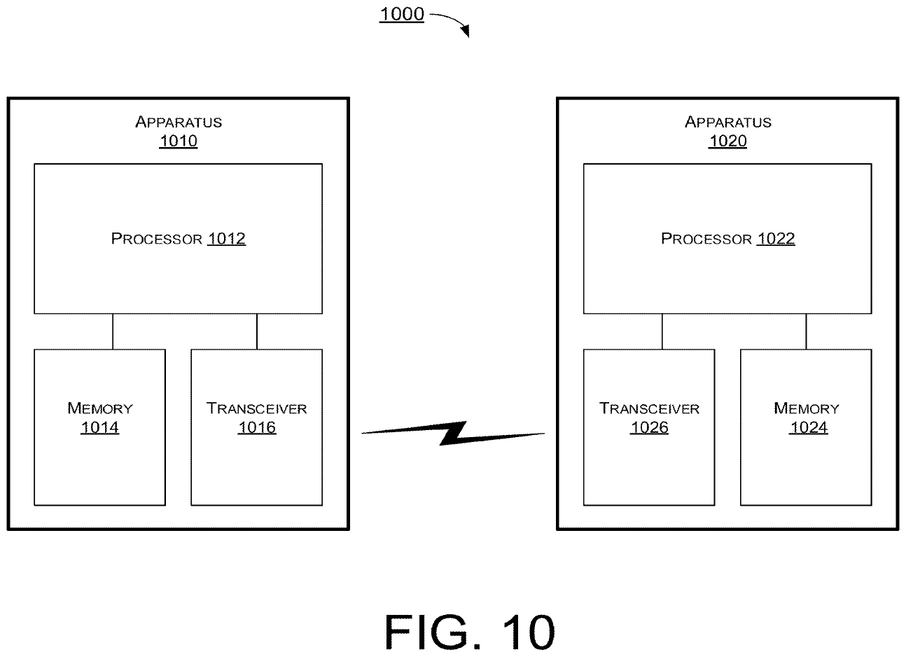

FIG. 10 illustrates an example communication system 1000 having at least an example apparatus 1010 and an example apparatus 1020 in accordance with an implementation of the present disclosure. Each of apparatus 1010 and apparatus 1020 may perform various functions to implement schemes, techniques, processes and methods described herein pertaining to CSI compression and decompression, including the various schemes described above with respect to various proposed designs, concepts, schemes, systems and methods described above, including network environment 100, as well as processes described below.

Each of apparatus 1010 and apparatus 1020 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 1010 and apparatus 1020 may be implemented in a smartphone, a smartwatch, a personal digital assistant, an electronic control unit (ECU) in a vehicle, a digital camera, or a computing equipment such as a tablet computer, a laptop computer or a notebook computer. Each of apparatus 1010 and apparatus 1020 may also be a part of a machine type apparatus, which may be an IoT apparatus such as an immobile or a stationary apparatus, a home apparatus, a roadside unit (RSU), a wire communication apparatus, or a computing apparatus. For instance, each of apparatus 1010 and apparatus 1020 may be implemented in a smart thermostat, a smart fridge, a smart door lock, a wireless speaker or a home control center. When implemented in or as a network apparatus, apparatus 1010 and/or apparatus 1020 may be implemented in an eNodeB in an LTE, LTE-Advanced or LTE-Advanced Pro network or in a gNB or TRP in a 5G network, an NR network or an IoT network.

In some implementations, each of apparatus 1010 and apparatus 1020 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 1010 and apparatus 1020 may be implemented in or as a network apparatus or a UE. Each of apparatus 1010 and apparatus 1020 may include at least some of those components shown in FIG. 10 such as a processor 1012 and a processor 1022, respectively, for example. Each of apparatus 1010 and apparatus 1020 may further include one or more other components not pertinent to the proposed scheme of the present disclosure (e.g., internal power supply, display device and/or user interface device), and, thus, such component(s) of apparatus 1010 and apparatus 1020 are neither shown in FIG. 10 nor described below in the interest of simplicity and brevity.

In one aspect, each of processor 1012 and processor 1022 may be implemented in the form of one or more single-core processors, one or more multi-core processors, or one or more CISC or RISC processors. That is, even though a singular term “a processor” is used herein to refer to processor 1012 and processor 1022, each of processor 1012 and processor 1022 may include multiple processors in some implementations and a single processor in other implementations in accordance with the present disclosure. In another aspect, each of processor 1012 and processor 1022 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1012 and processor 1022 is a special-purpose machine specifically designed, arranged and configured to perform specific tasks including those pertaining to monitoring of AI/ML models in wireless communications in accordance with various implementations of the present disclosure.

In some implementations, apparatus 1010 may also include a transceiver 1016 coupled to processor 1012. Transceiver 1016 may be capable of wirelessly transmitting and receiving data. In some implementations, transceiver 1016 may be capable of wirelessly communicating with different types of wireless networks of different radio access technologies (RATs). In some implementations, transceiver 1016 may be equipped with a plurality of antenna ports (not shown) such as, for example, four antenna ports. That is, transceiver 1016 may be equipped with multiple transmit antennas and multiple receive antennas for multiple-input multiple-output (MIMO) wireless communications. In some implementations, apparatus 1020 may also include a transceiver 1026 coupled to processor 1022. Transceiver 1026 may include a transceiver capable of wirelessly transmitting and receiving data. In some implementations, transceiver 1026 may be capable of wirelessly communicating with different types of UEs/wireless networks of different RATs. In some implementations, transceiver 1026 may be equipped with a plurality of antenna ports (not shown) such as, for example, four antenna ports. That is, transceiver 1026 may be equipped with multiple transmit antennas and multiple receive antennas for MIMO wireless communications.

In some implementations, apparatus 1010 may further include a memory 1014 coupled to processor 1012 and capable of being accessed by processor 1012 and storing data therein. In some implementations, apparatus 1020 may further include a memory 1024 coupled to processor 1022 and capable of being accessed by processor 1022 and storing data therein. Each of memory 1014 and memory 1024 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1014 and memory 1024 may include a type of read-only memory (ROM) such as mask ROM, programmable ROM (PROM), erasable programmable ROM (EPROM) and/or electrically erasable programmable ROM (EEPROM). Alternatively, or additionally, each of memory 1014 and memory 1024 may include a type of non-volatile random-access memory (NVRAM) such as flash memory, solid-state memory, ferroelectric RAM (FeRAM), magnetoresistive RAM (MRAM) and/or phase-change memory.

Each of apparatus 1010 and apparatus 1020 may be a communication entity capable of communicating with each other using various proposed schemes in accordance with the present disclosure. For illustrative purposes and without limitation, a description of capabilities of apparatus 1010, as a UE (e.g., UE 110), and apparatus 1020, as a network node (e.g., network node 125) of a network (e.g., network 130 as a 5G/NR mobile network), is provided below in the context of example process 1100.

### Illustrative Processes

FIG. 11 illustrates an example process 1100 in accordance with an implementation of the present disclosure. Process 1100 may represent an aspect of implementing various proposed designs, concepts, schemes, systems and methods described above pertaining to monitoring of AI/ML models in wireless communications, whether partially or entirely, including those pertaining to those described above. Process 1100 may include one or more operations, actions, or functions as illustrated by one or more of blocks. Although illustrated as discrete blocks, various blocks of each process may be divided into additional blocks, combined into fewer blocks, or eliminated, depending on the desired implementation. Moreover, the blocks/sub-blocks of each process may be executed in the order shown in each figure, or, alternatively in a different order. Furthermore, one or more of the blocks/sub-blocks of each process may be executed iteratively. Process 1100 may be implemented by or in apparatus 1010 and/or apparatus 1020 as well as any variations thereof. Solely for illustrative purposes and without limiting the scope, each process is described below in the context of apparatus 1010 as a UE (e.g., UE 110) and apparatus 1020 as a communication entity such as a network node or base station (e.g., terrestrial network node 120) of a network (e.g., a 5G/NR mobile network). Process 1100 may begin at block 1110.

At 1110, process 1100 may involve processor 1012 of apparatus 1010 (e.g., as UE 110) preparing a two-sided AI/ML model using information from a network (e.g., via apparatus 1020 as terrestrial network node 125 or non-terrestrial network node 128). Process 1100 may proceed from 1110 to 1120.

At 1120, process 1100 may involve processor 1012 monitoring the two-sided AI/ML model in a wireless communication with the network.

In some implementations, in preparing, process 1100 may involve processor 1012 training a proxy decoder of the two-sided AI/ML model.

In some implementations, in training the proxy decoder, process 1100 may involve processor 1012 training the proxy decoder via a single-vendor distillation by: (i) designing the proxy decoder based on constraints and needs of apparatus 1010 as a UE; (ii) sharing a dataset, which includes latent vectors and corresponding target samples, with a network node or a network node vendor; and (iii) transferring knowledge of a decoder of the network node to the UE by minimizing a loss function.

In some implementations, in training the proxy decoder, process 1100 may involve processor 1012 training the proxy decoder via a single-vendor distillation by: (i) learning from a network node vendor via a one-time interaction to train the proxy decoder; and (ii) training one or more other user equipment (UE) students to prepare one or more proxy decoders thereof.

In some implementations, in training the proxy decoder, process 1100 may involve processor 1012 training the proxy decoder via a single-vendor distillation by learning from a master student to train the proxy decoder. In such cases, the master student may have prepared its proxy decoder via a one-time interaction with a network node vendor.

In some implementations, in training the proxy decoder, process 1100 may involve processor 1012 training the proxy decoder via a multi-vendor distillation by learning from multiple network nodes or multiple network node vendors to train the proxy decoder. Moreover, process 1100 may involve processor 1012 training one or more other UE students to prepare one or more proxy decoders thereof.

In some implementations, in training the proxy decoder, process 1100 may involve processor 1012 training the proxy decoder via a multi-vendor distillation by learning from a master student to train the proxy decoder. In such cases, the master student may have prepared its proxy decoder by leaning from multiple network nodes or multiple network node vendors to train its proxy decoder.

In some implementations, in monitoring, process 1100 may involve processor 1012 monitoring with a distillated proxy decoder which is trained by knowledge distillated from a network node or a network node vendor.

In some implementations, in monitoring, process 1100 may involve processor 1012 performing KPI-based model monitoring. In some implementations, in performing the KPI-based model monitoring, process 1100 may involve processor 1012 performing certain operations. For instance, process 1100 may involve processor 1012 encoding and compressing an input to generate a latent vector. Moreover, process 1100 may involve processor 1012 measuring a drifted KPI by passing the latent vector through the distillated proxy decoder. Furthermore, process 1100 may involve processor 1012 reporting information of a monitoring event to a network responsive to the drifted KPI indicating the monitoring event.

In some implementations, in preparing, process 1100 may involve processor 1012 training the two-sided AI/ML model as a student model by: (i) sending a request to the network to initiate a knowledge distillation process; (ii) receiving a teacher model and corresponding soft values from the network responsive to the sending; (iii) obtaining the student model which is trained based on the teacher model and the corresponding soft values; and (iv) sending a signal to the network to indicate completion of the knowledge distillation process. In some implementations, in obtaining the student model, process 1100 may involve processor 1012 performing certain operations. For instance, process 1100 may involve processor 1012 sending the teacher model and the corresponding soft values to a server. Additionally, process 1100 may involve processor 1012 receiving the student model from the server which trains the student model based on the teacher model and the corresponding soft values.

In some implementations, in preparing, process 1100 may involve processor 1012 fine-tuning the two-sided AI/ML model as a student model by: (i) reporting a capability for fine-tuning to the network to initiate a fine-tuning process; (ii) receiving fine-tuning data from the network responsive to the reporting; (iii) obtaining the student model which is fine-tuned based on the fine-tuning data; and (iv) sending a signal to the network to indicate completion of the fine-tuning process. In some implementations, in obtaining the student model, process 1100 may involve processor 1012 performing certain operations. For instance, process 1100 may involve processor 1012 sending the fine-tuning data to a server. Additionally, process 1100 may involve processor 1012 receiving the student model from the server which fine-tunes the student model based on the fine-tuning data.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
preparing, by a processor of an apparatus, a two-sided artificial intelligence (AI)/machine learning (ML) model using information from a network; and
monitoring, by the processor, the two-sided AI/ML model in a wireless communication with the network.

2. The method of claim 1, wherein the preparing comprises training a proxy decoder of the two-sided AI/ML model.

3. The method of claim 2, wherein the training of the proxy decoder comprises training the proxy decoder via a single-vendor distillation by:
designing the proxy decoder based on constraints and needs of a user equipment (UE);
sharing a dataset, which includes latent vectors and corresponding target samples, with a network node or a network node vendor; and
transferring knowledge of a decoder of the network node to the UE by minimizing a loss function.

4. The method of claim 2, wherein the training of the proxy decoder comprises training the proxy decoder via a single-vendor distillation by:
learning from a network node vendor via a one-time interaction to train the proxy decoder; and
training one or more other user equipment (UE) students to prepare one or more proxy decoders thereof.

5. The method of claim 2, wherein the training of the proxy decoder comprises training the proxy decoder via a single-vendor distillation by:
learning from a master student to train the proxy decoder,
wherein the master student prepared its proxy decoder via a one-time interaction with a network node vendor.

6. The method of claim 2, wherein the training of the proxy decoder comprises training the proxy decoder via a multi-vendor distillation by learning from multiple network nodes or multiple network node vendors to train the proxy decoder.

7. The method of claim 6, further comprising:
training one or more other user equipment (UE) students to prepare one or more proxy decoders thereof.

8. The method of claim 2, wherein the training of the proxy decoder comprises training the proxy decoder via a multi-vendor distillation by:
learning from a master student to train the proxy decoder,
wherein the master student prepared its proxy decoder by leaning from multiple network nodes or multiple network node vendors to train its proxy decoder.

9. The method of claim 1, wherein the monitoring comprises monitoring with a distillated proxy decoder which is trained by knowledge distillated from a network node or a network node vendor.

10. The method of claim 9, wherein the monitoring comprises performing key performance indicator (KPI)-based model monitoring.

11. The method of claim 10, wherein the performing of the KPI-based model monitoring comprises:
encoding and compressing an input to generate a latent vector;
measuring a drifted KPI by passing the latent vector through the distillated proxy decoder; and
reporting information of a monitoring event to a network responsive to the drifted KPI indicating the monitoring event.

12. The method of claim 1, wherein the preparing comprises training the two-sided AI/ML model as a student model by:
sending a request to the network to initiate a knowledge distillation process;
receiving a teacher model and corresponding soft values from the network responsive to the sending;
obtaining the student model which is trained based on the teacher model and the corresponding soft values; and
sending a signal to the network to indicate completion of the knowledge distillation process.

13. The method of claim 12, wherein the obtaining of the student model comprises:
sending the teacher model and the corresponding soft values to a server; and
receiving the student model from the server which trains the student model based on the teacher model and the corresponding soft values.

14. The method of claim 1, wherein the preparing comprises fine-tuning the two-sided AI/ML model as a student model by:
reporting a capability for fine-tuning to the network to initiate a fine-tuning process;
receiving fine-tuning data from the network responsive to the reporting;
obtaining the student model which is fine-tuned based on the fine-tuning data; and
sending a signal to the network to indicate completion of the fine-tuning process.

15. The method of claim 14, wherein the obtaining of the student model comprises:
sending the fine-tuning data to a server; and
receiving the student model from the server which fine-tunes the student model based on the fine-tuning data.

16. An apparatus, comprising:
a transceiver configured to communicate wirelessly; and
a processor coupled to the transceiver and configured to perform operations comprising:
preparing a two-sided artificial intelligence (Al)/machine learning (ML) model using information from a network; and
monitoring the two-sided AI/ML model in a wireless communication with the network.

17. The apparatus of claim 16, wherein the preparing comprises training a proxy decoder of the two-sided AI/ML model, and wherein the training of the proxy decoder comprises training the proxy decoder via a single-vendor distillation by:
learning from a master student to train the proxy decoder,
wherein the master student prepared its proxy decoder via a one-time interaction with a network node vendor.

18. The apparatus of claim 16, wherein the preparing comprises training a proxy decoder of the two-sided AI/ML model, and wherein the training of the proxy decoder comprises training the proxy decoder via a multi-vendor distillation by:
learning from a master student to train the proxy decoder,
wherein the master student prepared its proxy decoder by leaning from multiple network nodes or multiple network node vendors to train its proxy decoder.

19. The apparatus of claim 16, wherein the preparing comprises training the two-sided AI/ML model as a student model by:
sending a request to the network to initiate a knowledge distillation process;
receiving a teacher model and corresponding soft values from the network responsive to the sending;
obtaining the student model which is trained based on the teacher model and the corresponding soft values; and
sending a signal to the network to indicate completion of the knowledge distillation process.

20. The apparatus of claim 16, wherein the preparing comprises fine-tuning the two-sided AI/ML model as a student model by:
reporting a capability for fine-tuning to the network to initiate a fine-tuning process;
receiving fine-tuning data from the network responsive to the reporting;
obtaining the student model which is fine-tuned based on the fine-tuning data; and
sending a signal to the network to indicate completion of the fine-tuning process.
